(19) United States
(12) Patent Application Publication
(10) Pub. No.: US 2018/0306285 A1
(43) Pub. Date: Oct. 25, 2018

(54) TRANSMISSION DEVICE AND DIFFERENTIAL DEVICE

(71) Applicant: MUSASHI SEIMITSU INDUSTRY CO., LTD., TOYOHASHI-SHI, AICHI (JP)

(72) Inventors: Takanori NOGUCHI, TOYOHASHI-SHI, AICHI (JP); Tetsuro HAMADA, TOYOHASHI-SHI, AICHI (JP); Shinya MATSUOKA, TOYOHASHI-SHI, AICHI (JP)

(21) Appl. No.: 15/771,654

(22) PCT Filed: Nov. 30, 2016
(86) PCT No.: PCT/JP2016/085614

§ 371 Date: Apr. 27, 2018

(30) Foreign Application Priority Data
Nov. 30, 2015 (JP) 2015-233473

(51) Int. Cl. F16H 25/06; F16H 48/14

(52) U.S. Cl. CPC F16H 25/06; F16H 2001/327; F16H 48/14

(57) ABSTRACT

A transmission device includes a first transmission member, an eccentric rotating member formed by integrally linking to each other a main shaft portion and an eccentric shaft portion, a second transmission member rotatably supported on the eccentric shaft portion, a third transmission member that opposes the second transmission member, a first transmission mechanism provided between the first and second transmission members, and a second transmission mechanism provided between the second and third transmission member. The second transmission member includes a first half body rotatably supported on the eccentric shaft portion, a second half body that opposes the first half body while sandwiching a housing space for the balance weight, and a linking member that links the two half bodies so as to surround the housing space, the linking member having a first access window that enables an operation of inserting the balance weight into the housing space.

### TECHNICAL FIELD

The present invention relates to a transmission device, in particular to a transmission device that includes a first transmission member that is disposed so as to have a first axis as a central axis, an eccentric rotating member that is formed by integrally linking to each other a main shaft portion that is rotatable around the first axis and an eccentric shaft portion that has as a central axis a second axis that is eccentric from the first axis, a second transmission member that is rotatably supported on the eccentric shaft portion, a third transmission member that is disposed so as to have the first axis as a central axis and opposes the second transmission member, a first transmission mechanism that can transmit torque between the first and second transmission members while changing speed, and a second transmission mechanism that can transmit torque between the second and third transmission members while changing speed, and to a differential device utilizing the transmission device.

### BACKGROUND ART

The above transmission device is conventionally known, as disclosed in for example Patent Document 1, and in this arrangement the center of gravity of an eccentric rotation system that includes an eccentric shaft portion of an eccentric rotating member and a second transmission member is displaced at a position spaced from a first axis in a direction toward a second axis. Because of this, when the second transmission member revolves around the first axis with respect to a main shaft portion while spinning around the second axis with respect to the eccentric shaft portion of the eccentric rotating member accompanying rotation of the eccentric rotating member around the first axis, the centrifugal force of the eccentric rotation system acts with a large bias in a specific direction (that is, the offset side of the second axis) with respect to the first axis, rotation of the eccentric rotation system attains an imbalanced state, and this becomes a main cause for vibration of the device.

In the transmission device of Patent Document 1, the eccentric rotation system is provided with a balance weight in order to alleviate an imbalanced state of rotation thereof.

### RELATED ART DOCUMENTS

### Patent Documents

Patent Document 1: Japanese Patent No. 4814351

### SUMMARY OF THE INVENTION

### Problems to be Solved by the Invention

However, in the transmission device of Patent Document 1, a balance weight 12c is housed in a weight-housing space formed on the radially inner side of the first transmission member (fixed plate 3), and the balance weight 12c adjoins and is fixed to a main shaft portion 12b of an eccentric rotating member 12 further outside in the axial direction than a second transmission member 4. Because of this, first transmission mechanisms 6, 7, and 10 disposed between the first and second transmission members 3 and 4 are present around the balance weight 12c, and it therefore becomes difficult to install a balance weight having a rotational radius that is sufficiently larger than the rotational radius of the overall center of gravity of the eccentric shaft portion 12d of the eccentric rotating member 12 and the second transmission member 4 due to interference from the first transmission mechanism. Therefore, if an attempt is made to ensure that there is sufficient centrifugal force acting on the balance weight, it is inevitable that a large weight is set for the weight, and this is disadvantageous in terms of lightening the weight of the differential device.

Furthermore, as described above, the center of gravity of the balance weight 12c that adjoins and is fixed to the main shaft portion 12b of the eccentric rotating member 12 further outside in the axial direction than the second transmission member 4 is inevitably offset in the axial direction to a considerable degree with respect to the overall center of gravity of the eccentric shaft portion 12d and the second transmission member 4, centrifugal forces acting on the two centers of gravity and facing in opposite directions to each other generate a considerable amount of coupling force against the eccentric rotation system, which includes the eccentric rotating member 12 and the second transmission member 4, and this becomes a main cause for the occurrence of vibration.

The present invention has been accomplished in light of such circumstances, and it is an object thereof to provide a transmission device and a differential device that can solve the above problems at once.

### Means for Solving the Problems

In order to attain the above object, according to a first aspect of the present invention, there is provided a transmission device comprising a first transmission member that is disposed so as to have a first axis as a central axis, an eccentric rotating member that is formed by integrally linking to each other a main shaft portion that is rotatable around the first axis and an eccentric shaft portion that has as a central axis a second axis that is eccentric from the first axis, a second transmission member that is rotatably supported on the eccentric shaft portion, a third transmission member that is disposed so as to have the first axis as a central axis and opposes the second transmission member, a first transmission mechanism that can transmit torque between the first and second transmission members while changing speed, a second transmission mechanism that can transmit torque between the second and third transmission members while changing speed, and a balance weight that is provided on the main shaft portion, has an opposite phase to an overall center of gravity of the eccentric shaft portion and the second transmission member with respect to the first axis, and has a rotational radius that is larger than a rotational radius of the overall center of gravity, the second transmission member comprising a first half body that is rotatably supported on the eccentric shaft portion, a second half body that opposes the first half body while sandwiching a housing space for the balance weight, and a linking member that integrally links the two half bodies so as to surround the housing space, the first transmission mechanism being provided between the first half body and the first transmission member, and the second transmission mechanism being provided between the second half body and the third transmission member, and the linking member having a first access window that enables an operation of inserting the balance weight into the housing space.

Further, according to a second aspect of the present invention, in addition to the first aspect, the balance weight is relatively non-rotatably fitted on the main shaft portion, a retaining member that prevents the balance weight from disengaging from the main shaft portion is fitted on the main shaft portion, and the second half body has a second access window that enables an operation of fitting the retaining member on the main shaft portion.

Furthermore, according to a third aspect of the present invention, in addition to the first or second aspect, the second transmission member is formed from a sintered product in which the two half bodies and the linking member are integrally molded.

Moreover, according to a fourth aspect of the present invention, in addition to any one of the first to third aspects, the first transmission mechanism having a first transmission groove that is present in a face, opposing the first half body, of the first transmission member and has a wave form annular shape having the first axis as a center, a second transmission groove that is present in a face, opposing the first transmission member, of the first half body, has a wave form annular shape having the second axis as a center, and has a wave number that is different from that of the first transmission groove, and a plurality of first rolling bodies that are disposed on a plurality of intersecting parts of the first and second transmission grooves and carry out speed change and transmission between the first transmission member and the first half body while rolling on the first and second transmission grooves, and the second transmission mechanism having a third transmission groove that is present in a face, opposing the third transmission member, of the second half body and has a wave form annular shape having the second axis as a center, a fourth transmission groove that is present in a face, opposing the second half body, of the third transmission member, has a wave form annular shape having the first axis as a center, and has a wave number that is different from that of the third transmission groove, and a plurality of second rolling bodies that are disposed on a plurality of intersecting parts of the third and fourth transmission grooves and carry out speed change and transmission between the second half body and the third transmission member while rolling on the third and fourth transmission grooves.

Further, according to a fifth aspect of the present invention, there is provided a differential device utilizing the transmission device having the fourth aspect, the differential device comprising a differential case that has power inputted and rotates integrally with the first transmission member around the first axis, the differential case having rotatably supported thereon a first drive shaft connected to the main shaft portion and a second drive shaft connected to the third transmission member, and (Z1/Z2)×(Z3/Z4)=2 being satisfied, where the wave number of the first transmission groove is Z1, the wave number of the second transmission groove is Z2, the wave number of the third transmission groove is Z3, and the wave number of the fourth transmission groove is Z4.

### Effects of the Invention

In accordance with the first aspect of the present invention, since the second transmission member includes the first half body rotatably supported on the eccentric shaft portion of the eccentric rotating member, the second half body opposing the first half body while sandwiching the housing space for the balance weight, and the linking member integrally linking the two half bodies so as to surround the housing space, the first transmission mechanism being provided between the first half body and the first transmission member, and the second transmission mechanism being provided between the second half body and the third transmission member, and the balance weight has an opposite phase to the overall center of gravity of the eccentric shaft portion and the second transmission member with respect to the first axis, has a rotational radius larger than the rotational radius of the overall center of gravity, and is provided on the main shaft portion of the eccentric rotating member, it is possible to substantially balance the centrifugal force acting on the overall center of gravity of the eccentric shaft portion and the second transmission member and the centrifugal force acting on the center of gravity of the balance weight while lightening the weight of the balance weight and consequently the transmission device, thus enabling the occurrence of vibration due to eccentric rotation of the eccentric shaft portion and the second transmission member to be suppressed effectively. Moreover, since the position in the axial direction of the overall center of gravity of the eccentric shaft portion and the second transmission member can be easily adjusted by distributing the weight between the first and second half bodies, it becomes possible to make the amount of axial offset of the overall center of gravity with respect to the center of gravity of the balance weight zero or close to zero, and this enables the occurrence of the coupling force caused by the centrifugal forces acting on the two centers of gravity to be made zero or close to zero, thus enabling the occurrence of vibration due to the coupling force to be suppressed or reduced.

Furthermore, since the linking member between the first and second half bodies has the first access window, which enables an operation of inserting the balance weight into the housing space, for example, even after the second transmission member is produced in advance from the two half bodies and the linking member and is fitted on the eccentric shaft portion of the eccentric rotating member, it is possible to mount the balance weight on the main shaft portion by inserting it into the housing space on the inner side of the linking member through the first access window and, moreover, since the second transmission member can be produced in advance, post-treatments such as removal of burrs and cleaning after production can be carried out without affecting other objects such as the balance weight, which is convenient. Furthermore, since the first access window is a hole that is cut out of the linking member, it can contribute to lightening the weight of the second transmission member.

Furthermore, in accordance with the second aspect of the present invention, since the balance weight is relatively non-rotatably fitted on the main shaft portion, the retaining member, which prevents the balance weight from disengaging from the main shaft portion, is fitted on the main shaft portion, and the second half body has the second access window, which enables an operation of fitting the retaining member on the main shaft portion, it is possible to fit the retaining member on the main shaft portion through the second access window of the second half body after inserting the balance weight into the housing space within the linking member through the first access window of the linking member between the two half bodies and non-rotatably fitting it on the main shaft portion, and the ease of mounting the balance weight becomes good. Moreover, since the second access window is a hole that is cut out of the second half body, it is possible to contribute to lightening the weight of the second transmission member.

Moreover, in accordance with the third aspect of the present invention, since the second transmission member is formed from a sintered product in which the two half bodies and the linking member are integrally molded, the second transmission member is a seamless single component, and the number of components and the number of assembly steps are reduced, thus cutting the cost. Even if the second transmission member is formed as a single product in this way, it becomes possible to carry out an operation of mounting the balance weight through the access window without any problems.

Furthermore, in accordance with the fourth aspect of the present invention, since torque is transmitted between the first and second transmission members via the plurality of first rolling bodies present on the plurality of mutually intersecting parts of the wave form annular first and second transmission grooves having different wave numbers (i.e. dispersed between the plurality of locations in the peripheral direction), and torque is transmitted between the second and third transmission members via the plurality of second rolling bodies present on the mutually intersecting parts of the wave form annular third and fourth transmission grooves having different wave numbers (i.e. dispersed between the plurality of locations in the peripheral direction), the burden on each transmission element is alleviated, the strength increases, and the weight is lightened. Moreover, since the first and second transmission mechanisms of the transmission device can be flattened in the axial direction, this can contribute to flattening of the transmission device in the axial direction.

Moreover, in accordance with the fifth aspect of the present invention, the transmission device can be utilized as a differential device that is flat in the axial direction.

### BRIEF DESCRIPTION OF DRAWINGS

FIG. 1 is a vertical sectional front view of a differential device related to one embodiment of the present invention. (first embodiment)

FIG. 2 is an exploded perspective view of an essential part (differential mechanism) of the differential device. (first embodiment)

FIG. 3 is a sectional view from arrowed line 3-3 in FIG. 1. (first embodiment)

FIG. 4 is a sectional view from arrowed line 4-4 in FIG. 1. (first embodiment)

FIG. 5 is a sectional view from arrowed line 5-5 in FIG. 1. (first embodiment)

### EXPLANATION OF REFERENCE NUMERALS AND SYMBOLS

C Differential case as transmission case
D Differential device as transmission device
G Overall center of gravity
S1 Right drive axle as first drive shaft
S2 Left drive axle as second drive shaft
SP Housing space
T1, T2 First and second transmission mechanisms
W Balance weight
X1, X2 First and second axes
5 First transmission member
6 Eccentric rotating member
6j Main shaft portion
6e Eccentric shaft portion
8 Second transmission member
8a, 8b First and second half bodies
8c Linking member
9 Third transmission member
10 Circlip as retaining member
11, 12 First and second access windows
21, 22 First and second transmission grooves
23 First rolling ball as first rolling body
24, 25 Third and fourth transmission grooves
26 Second rolling ball as second rolling body

### MODES FOR CARRYING OUT THE INVENTION

An embodiment of the present invention is explained below by reference to the attached drawings.

### First Embodiment

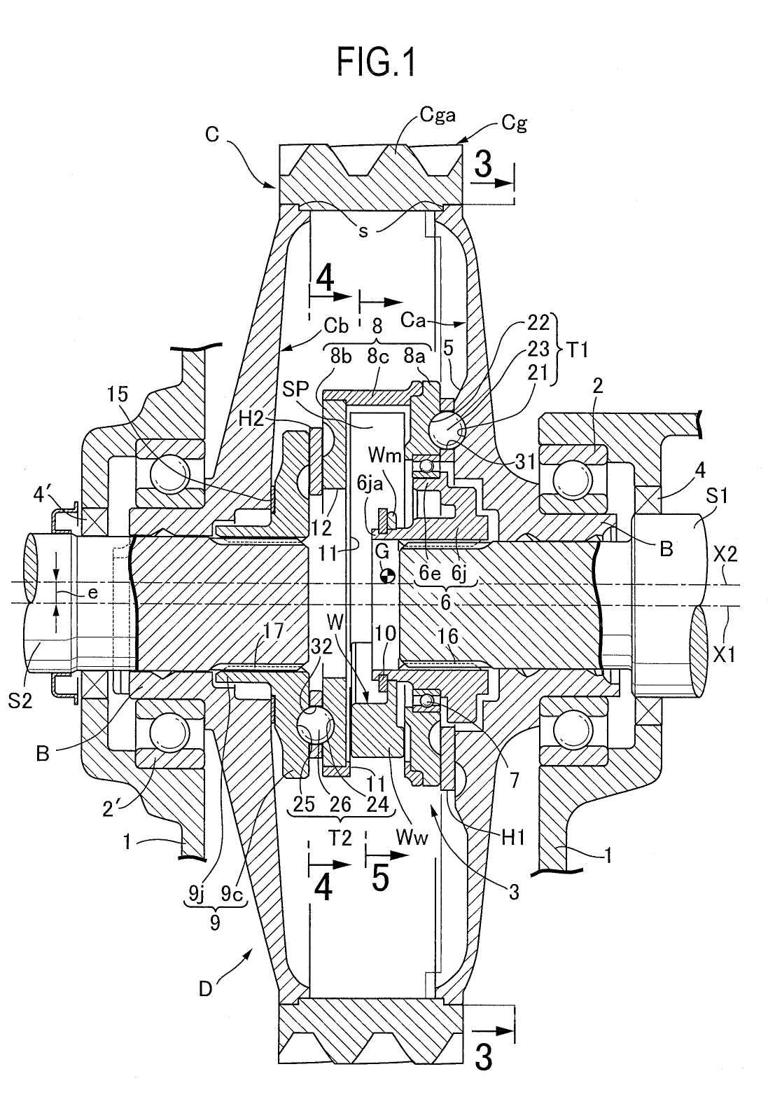

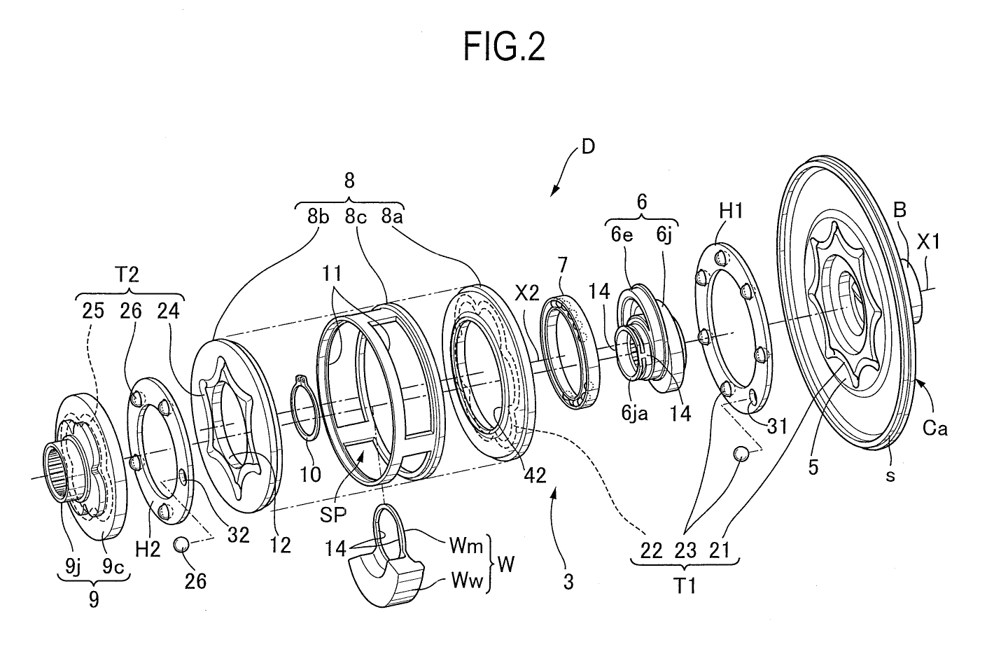

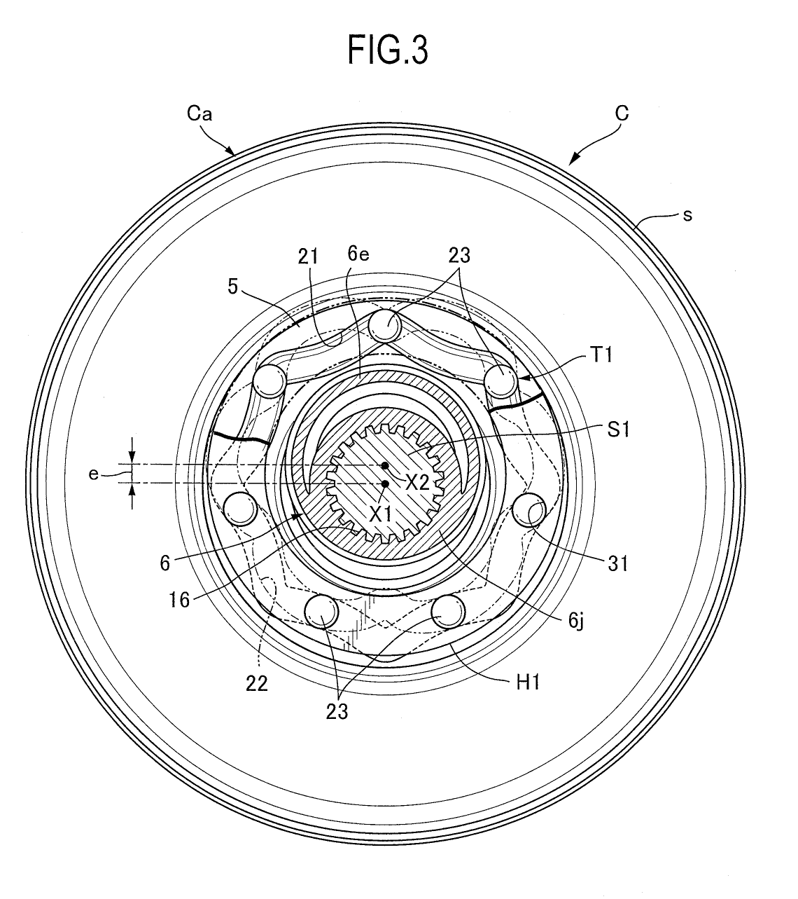

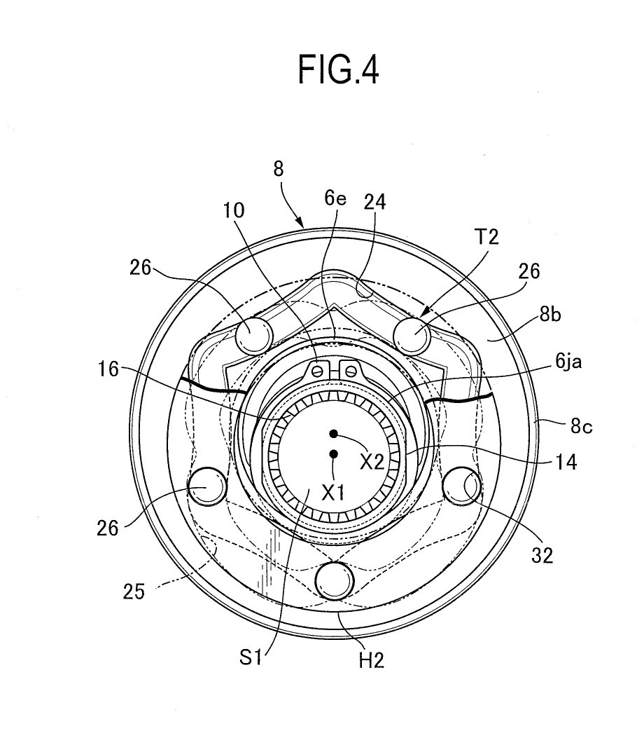

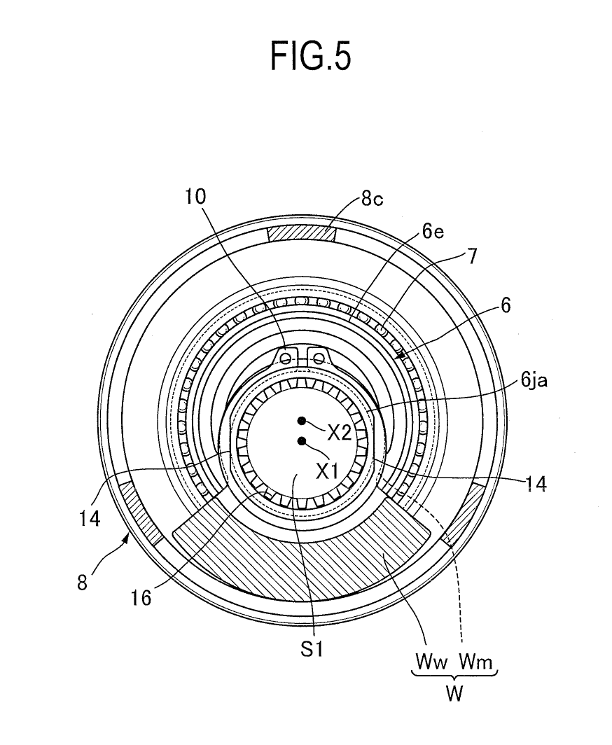

First, one embodiment of the present invention shown in FIG. 1 to FIG. 5 is explained. In FIG. 1, a differential device D as a transmission device is housed within a transmission case 1 of an automobile together with a speed change device.

This differential device D distributes rotation of a ring gear Cg that rotates in association with the output side of the speed change device between left and right drive axles S1 and S2 (i.e. drive shafts) relatively rotatably arranged on the central axis of the differential device D, that is, on a first axis X1, while allowing differential rotation between the two drive axles S1 and S2. It should be noted here that seal members 4 and 4′ provide sealing between the drive axles S1 and S2 and the transmission case 1.

The differential device D is formed from a differential case C supported on the transmission case 1 so as to be rotatable around the first axis X1 and a differential mechanism 3, which is described later, housed within the differential case C. The differential case C includes the ring gear Cg, which is a helical gear having helical teeth Cga provided on the outer periphery of a short cylindrical gear main body, and a pair of left and right first and second side wall plate portions Ca and Cb having outer peripheral end parts joined to axially opposite end parts of the ring gear Cg.

The two side wall plate portions Ca and Cb integrally have a boss part B on an inner peripheral end part thereof, and an outer peripheral part of the boss part B is supported on the transmission case 1 via bearings 2 and 2′ so as to be rotatable around the first axis X1. Furthermore, the first and second drive axles S1 and S2 having the first axis X1 as a rotational axis are rotatably fitted and supported on the inner peripheral part of the boss part B.

Joining faces of the outer peripheral end parts of the first and second side wall plate portions Ca and Cb and the ring gear Cg are integrally joined by appropriate joining means such as welding, adhesion, or swaging. A step s is formed on the joining faces, and this step s enhances effectively the precision of axial positioning and the strength of joining between the outer peripheral end part of each of the side wall plate portions Ca and Cb and the ring gear Cg.

The structure of the differential mechanism 3 within the differential case C is now explained. The differential mechanism 3 includes a first transmission member 5 that is provided integrally with the first side wall plate portion Ca and is rotatable around the first axis X1, an eccentric rotating member 6 formed by integrally linking to each other a main shaft portion 6j that is fitted onto the first drive axle S1 by a spline fitting 16 and is rotatable around the first axis X1, and an eccentric shaft portion 6e that has as a central axis a second axis X2 that is eccentric from the first axis X1 only by a predetermined amount e, an annular second transmission member 8 that is disposed so that one side part thereof faces the first transmission member 5 and that is rotatably supported on the eccentric shaft portion 6e via a bearing 7, an annular third transmission member 9 that is disposed so as to face the other side part of the second transmission member 8, is fitted onto the second drive axle S2 by a spline fitting 17, and is rotatable around the first axis X1, a first transmission mechanism T1 that can transmit torque between the first and second transmission members 5 and 8 while changing the speed, and a second transmission mechanism T2 that can transmit torque between the second and third transmission members 8 and 9 while changing the speed.

Due to the second transmission member 8 being fitted and supported, so as to be rotatable around the second axis X2, on the eccentric shaft portion 6e of the eccentric rotating member 6 having the main shaft portion 6j supported so as to be rotatable around the first axis X1, the second transmission member 8 can revolve around the first axis X1 with respect to the main shaft portion 6j while spinning around the second axis X2 with respect to the eccentric shaft portion 6e accompanying rotation of the eccentric rotating member 6 around the first axis X1.

Furthermore, the second transmission member 8 includes an annular first half body 8a that is rotatably supported on the eccentric shaft portion 6e of the eccentric rotating member 6 via a bearing 7, an annular second half body 8b that opposes the first half body 8a while sandwiching a housing space SP for a balance weight W, which is described later, and a basically cylindrical linking member 8c that integrally links the two half bodies 8a and 8b so as to surround the housing space SP, the first transmission mechanism T1 being provided between the first half body 8a and the first transmission member 5, and the second transmission mechanism T2 being provided between the second half body 8b and the third transmission member 9.

Furthermore, the third transmission member 9 is formed by integrally joining a main shaft portion 9j that is fitted onto the second drive axle S2 by the spline fitting 17 and is rotatable around the first axis X1, and a disk portion 9c that is coaxially connected to an inner end part of the main shaft portion 9j. It should be noted here that a thrust washer 15 is relatively rotatably disposed between an inside face of the second side wall plate portion Cb and the third transmission member 9 (a back face of the disk portion 9c).

Moreover, the differential mechanism 3 includes a balance weight W that has an opposite phase to an overall center of gravity G of the eccentric shaft portion 6e of the eccentric rotating member 6 and the second transmission member 8 with respect to the first axis X1, has a rotational radius that is larger than the rotational radius of the overall center of gravity G, and is mounted on the main shaft portion 6j of the eccentric rotating member 6. This balance weight W is formed from an annular mounting base part Wm and a weight part Ww that is fixedly provided in a specific region in the peripheral direction of the mounting base part Wm.

An interior space of the second transmission member 8 (linking member 8c) acts as the housing space SP for housing the balance weight W. The main shaft portion 6j of the eccentric rotating member 6 has its inner end part extending to the housing space SP, and the balance weight W is fitted around the outer periphery of an extending end portion 6ja. The mounting base part Wm is fitted around the outer periphery of the extending end portion 6ja of the main shaft portion 6j, and a rotation-preventing flat engagement face 14 is provided between mating faces thereof, the engagement face 14 allowing axial sliding therebetween but restricting relative rotation. Fixing of the balance weight W to the main shaft portion 6j is carried out by detachably fitting onto the extending end portion 6ja of the main shaft portion 6j a retaining ring 10 such as a circlip as a retaining member that prevents the mounting base part Wm from disengaging from the main shaft portion 6j. For the fitting, a latching groove with which the retaining ring 10 can resiliently latch is provided in the outer periphery of the extending end portion 6ja of the main shaft portion 6j.

Furthermore, formed in a peripheral wall of the linking member 8c of the second transmission member 8 is a first access window 11 that allows an operation of inserting the balance weight W into the housing space SP in order to mount the balance weight W. The shape of this first access window 11 opening is set so as to have a shape and size that enables the balance weight W to be inserted into the housing space SP from the outer side of the linking member 8c.

Moreover, formed in the second half body 8b of the second transmission member 8 is a second access window 12 that enables an operation of fitting the retaining ring 10 onto the main shaft portion 6j (the extending end portion 6ja). The shape of this second access window 12 opening is set so as to have a shape and size that enables the retaining ring 10 to be inserted into the housing space SP from the exterior of the second half body 8b (e.g. a diameter larger than that of the retaining ring 10).

Therefore, even after the second transmission member 8 is produced in advance by joining to each other the two half bodies 8a and 8b and the linking member 8c and this is fitted onto the eccentric shaft portion 6e of the eccentric rotating member 6 via the bearing 7, the balance weight W can be inserted into the housing space SP on the inner side of the linking member 8c through the first access window 11 and mounted (specifically, non-rotatably fitted) on the main shaft portion 6j of the eccentric rotating member 6, the retaining ring 10 is then fitted on the main shaft portion 6j through the second access window 12 of the second half body 8b to thus enable the balance weight W to be fixed to the main shaft portion 6j, and it is therefore possible to easily and appropriately carry out this series of operations of mounting the balance weight W. Furthermore, since assembly and production of the second transmission member 8 can be carried out independently in advance as described above, post-treatments such as removal of burrs and cleaning after production can be carried out without affecting other objects such as the balance weight W, which is convenient. Moreover, since the first and second access windows 11 and 12 are holes that are cut out of the linking member 8c and the second half body 8b, the weight of the second transmission member 8 can be lightened.

After the steps of assembling the second transmission member 8, attaching the eccentric rotating member 6 thereto, and fitting the balance weight W, an operation of assembling the differential case C can be carried out by incorporating these collectively into the differential case C.

As shown in FIG. 1 to FIG. 3, a wave form annular first transmission groove 21 having the first axis X1 as a center is formed in an inside face, opposing one side face (that is, the first half body 8a) of the second transmission member 8, of the first transmission member 5, and this first transmission groove 21 extends in the peripheral direction along a hypotrochoid curve having as a base circle a virtual circle having the first axis X1 as a center in the illustrated example. On the other hand, a wave form annular second transmission groove 22 having the second axis X2 as a center is formed in an inside face (first half body 8a), opposing the first transmission member 5, of the second transmission member 8. This second transmission groove 22 extends in the peripheral direction along an epitrochoid curve having as a base circle a virtual circle having the second axis X2 as a center in the illustrated example, has a smaller wave number than that of the first transmission groove 21, and intersects the first transmission groove 21 at a plurality of locations. Disposed on these intersecting parts (i.e. overlapping parts) between the first transmission groove 21 and the second transmission groove 22 are a plurality of first rolling balls 23 as first rolling bodies, each first rolling ball 23 being capable of rolling on inside faces of the first and second transmission grooves 21 and 22.

An annular flat first retaining member H1 is disposed between mutually opposing faces of the first transmission member 5 and the second transmission member 8 (the first half body 8a). This first retaining member H1 has a plurality of circular retaining holes 31 that rotatably retain the plurality of first rolling balls 23 while holding the gaps therebetween constant so that a state in which the plurality of first rolling balls 23 engage with the first and second transmission grooves 21 and 22 via the mutually intersecting parts of the two transmission grooves 21 and 22 can be maintained. This suppresses effectively disturbance of each of the first rolling balls 23 within the first and second transmission grooves 21 and 22 when passing through a sharply changing curvature part of the groove, thus enabling the first rolling ball 23 to smoothly roll even in the sharply changing curvature part and thereby enhancing the transmission efficiency.

Moreover, as shown in FIGS. 1, 2, and 4, formed in the other side face (i.e. the second half body 8b) of the second transmission member 8 is a wave form annular third transmission groove 24 having the second axis X2 as a center, this third transmission groove 24 extending in the peripheral direction along a hypotrochoid curve having as a base circle a virtual circle having the second axis X2 as a center in the illustrated example. On the other hand, a wave form annular fourth transmission groove 25 having the first axis X1 as a center is formed in a face, opposing the second transmission member 8, of the third transmission member 9, that is, the inside face of the disk portion 9c. This fourth transmission groove 25 extends in the peripheral direction along an epitrochoid curve having as a base circle a virtual circle having the first axis X1 as a center in the illustrated example, has a smaller wave number than the wave number of the third transmission groove 24, and intersects the third transmission groove 24 at a plurality of locations. A plurality of second rolling balls 26 are disposed as second rolling bodies in the intersecting parts (overlapping parts) between the third transmission groove 24 and the fourth transmission groove 25, and each second rolling ball 26 can freely roll on the inside faces of the third and fourth transmission grooves 24 and 25.

An annular flat second retaining member H2 is disposed between mutually opposing faces of the third transmission member 9 and the second transmission member 8 (the second half body 8b). This second retaining member H2 has a plurality of circular retaining holes 32 that rotatably retain the plurality of second rolling balls 26 while holding the gaps therebetween constant so that a state in which the plurality of second rolling balls 26 engage with the third and fourth transmission grooves 24 and 25 via the mutually intersecting parts of the two transmission grooves 24 and 25 can be maintained. This suppresses effectively disturbance of each of the second rolling balls 26 within the third and fourth transmission grooves 24 and 25 when passing through a sharply changing curvature part of the groove, thus enabling the second rolling balls 26 to smoothly roll even in the sharply changing curvature part and thereby enhancing the transmission efficiency.

In the explanation above, when the wave number of the first transmission groove 21 is Z1, the wave number of the second transmission groove 22 is Z2, the wave number of the third transmission groove 24 is Z3, and the wave number of the fourth transmission groove 25 is Z4, the first to fourth transmission grooves 21, 22, 24, and 25 are formed so as to satisfy the equation below.

(Z1/Z2)×(Z3/Z4)=2

Desirably, as in the illustrated example Z1=8, Z2=6, Z3=6, and Z4=4, or Z1=6, Z2=4, Z3=8, and Z4=6.

In the illustrated example, the first transmission groove 21 having eight waves and the second transmission groove 22 having six waves intersect each other at seven positions, seven first rolling balls 23 being disposed in the seven intersecting parts (overlapping parts), and the third transmission groove 24 having six waves and the fourth transmission groove 25 having four waves intersect each other at five positions, five second rolling balls 26 being disposed in the five intersecting parts (overlapping parts).

The first transmission groove 21, the second transmission groove 22 and the first rolling ball 23 form in cooperation with each other the first transmission mechanism T1 that can transmit torque between the first transmission member 5 and the second transmission member 8 while changing the speed, and the third transmission groove 24, the fourth transmission groove 25 and the second rolling ball 26 form in cooperation with each other the second transmission mechanism T2 that can transmit torque between the second transmission member 8 and the third transmission member 9 while changing the speed.

The operation of the embodiment is now explained.

When, for example, in a state in which the eccentric rotating member 6 (and consequently the eccentric shaft portion 6e) is fixed by fixing the right first drive axle S1, the ring gear Cg is driven with power from an engine, and the differential case C, and consequently the first transmission member 5, is rotated around the first axis X1, the eight-wave first transmission groove 21 of the first transmission member 5 drives the six-wave second transmission groove 22 of the second transmission member 8 via the first rolling ball 23, and the first transmission member 5 therefore drives the second transmission member 8 with a speed increase ratio of 8/6. In response to this rotation of the second transmission member 8, the six-wave third transmission groove 24 of the second transmission member 8 drives the four-wave fourth transmission groove 25 of the disk portion 9c of the third transmission member 9 via the second rolling ball 26, and the second transmission member 8 therefore drives the third transmission member 9 with a speed increase ratio of 6/4.

As a result, the first transmission member 5 drives the third transmission member 9 with a speed increase ratio of

(Z1/Z2)×(Z3/Z4)=(8/6)×(6/4)=2.

On the other hand, when the differential case (and consequently the first transmission member 5) is rotated in a state in which the third transmission member 9 is fixed by fixing the left second drive axle S2, with the rotational driving force of the first transmission member 5 and the drive reaction force, relative to the immobile third transmission member 9, of the second transmission member 8, the second transmission member 8 revolves around the first axis X1 while spinning around the eccentric shaft portion 6e (second axis X2) of the eccentric rotating member 6, thus driving the eccentric shaft portion 6e around the first axis X1. As a result, the first transmission member 5 drives the eccentric rotating member 6 with a speed increase ratio of two times.

If the loads of the eccentric rotating member 6 and the third transmission member 9 are balanced or interchanged, the amount of spinning and the amount of revolving of the second transmission member 8 change steplessly, and the average value for the rotational speed of the eccentric rotating member 6 and the third transmission member 9 becomes equal to the rotational speed of the first transmission member 5. Rotation of the first transmission member 5 is thus distributed between the eccentric rotating member 6 and the third transmission member 9, and the rotational power transmitted from the ring gear Cg to the differential case C can be distributed between the left and right drive axles S1 and S2.

In this arrangement, it becomes possible by satisfying Z1=8, Z2=6, Z3=6 and Z4=4 or Z1=6, Z2=4, Z3=8 and Z4=6 to simplify the structure while ensuring a differential function.

In the differential device D, since the rotational torque of the first transmission member 5 is transmitted to the second transmission member 8 via the first transmission groove 21, the plurality of first rolling ball 23 and the second transmission groove 22, and the rotational torque of the second transmission member 8 is transmitted to the third transmission member 9 via the third transmission groove 24, the plurality of second rolling balls 26 and the fourth transmission groove 25, transmission of torque between the first transmission member 5 and the second transmission member 8 and between the second transmission member 8 and the third transmission member 9 is carried out while being dispersed between the plurality of locations where the first and second rolling balls 23 and 26 are present, and it is possible to enhance the strength and lighten the weight of transmission elements such as the first to third transmission members 5, 8 and 9 and the first and second rolling balls 23 and 26.

In the present embodiment, the position of an overall center of gravity G of the eccentric shaft portion 6e of the eccentric rotating member 6 and the second transmission member 8 is displaced at a position spaced from the first axis X1 in a direction toward the second axis X2. Because of this, when the second transmission member 8 revolves around the first axis X1 while spinning around the second axis X2 as described above, the centrifugal force of the eccentric rotation system acts with a bias in a specific direction (the side offset to the second axis X2) with respect to the first axis X1, and rotation of the eccentric rotation system attains an imbalanced state, but in order to eliminate or alleviate the imbalanced state of rotation, in this embodiment the balance weight W having a phase opposite to the overall center of gravity G and a rotational radius larger than the rotational radius of the overall center of gravity G is mounted on the main shaft portion 6j of the eccentric rotating member 6. Since it thus becomes possible to substantially balance the centrifugal force acting on the overall center of gravity G and the centrifugal force acting on the center of gravity of the balance weight W while lightening the weight of the balance weight W, and consequently the differential device D, it becomes possible to suppress effectively the occurrence of vibration due to the eccentric rotation of the eccentric shaft portion 6e and the second transmission member 8.

Moreover, since the position in the axial direction of the overall center of gravity G can be easily adjusted by appropriately distributing the weight between the first and second half bodies 8a and 8b, which dividedly form the second transmission member 8, it becomes possible to make the amount of axial offset of the overall center of gravity G with respect to the center of gravity of the balance weight zero or close to zero, and this enables the occurrence of the coupling force caused by the centrifugal forces acting on the two centers of gravity to be made zero or close to zero, thus enabling the occurrence of vibration due to the coupling force to be suppressed or reduced.

An embodiment of the present invention is explained above, but the present invention may be modified in a variety of ways as long as the modifications do not depart from the spirit and scope thereof.

For example, in the embodiment, the differential device D is illustrated as the transmission device, and the power inputted from the power source into the differential case C (the first transmission member 5) is distributed between the eccentric rotating member 6 and the third transmission member 9 via the second transmission member 8 and the first and second transmission mechanisms T1 and T2 while allowing differential rotation, but the present invention can be applied to various types of transmission devices other than a differential device.

Furthermore, the differential device D of the embodiment can be converted to a transmission (a reduction gear or a speed-increasing gear) by defining a casing corresponding to the differential case C of the embodiment as a fixed transmission case, defining either one of the eccentric rotating member 6 and the third transmission member 9 as an input shaft, and defining the other thereof as an output shaft, the rotational torque inputted into the input shaft being changed in speed (decreased in speed or increased in speed) and transmitted to the output shaft, and in this case such a transmission (reduction gear or speed-increasing gear) is considered to be the transmission device of the present invention.

Furthermore, in the embodiment, the differential device D as a transmission device is housed within an automobile transmission case M, but the differential device D is not limited to a differential device for an automobile and may be applied to a differential device for various types of machines and devices.

Moreover, in the embodiment, a case is illustrated in which the differential device D as a transmission device is applied to a left and right wheel transmission system, and distributes power between the left and right drive axles S1 and S2 while allowing differential rotation, but in the present invention a differential device as a transmission device may be applied to a front and rear wheel transmission system in a front and rear wheel drive vehicle, and the power may be distributed between the front and rear driven wheels while allowing differential rotation.

Furthermore, in the illustrated example the second transmission member 8 of the embodiment is formed by separately producing the first and second half bodies 8a and 8b and the linking member 8c and integrally joining the three, but in the present invention another embodiment (not illustrated) can be contemplated in which the second transmission member 8 may be formed from a single body (e.g. a sintered product) in which the first and second half bodies 8a and 8b and the linking member 8c are molded integrally. In accordance with the other embodiment, the second transmission member 8 is a seamless single component, and the number of components and the number of assembly steps can be reduced, thus cutting the cost. As in the embodiment illustrated in the drawings, when the first and second half bodies 8a and 8b and the linking member 8c are produced separately, each component can be made small in size, and there is the advantage that production is easy, etc.

Furthermore, in the embodiment, a case is illustrated in which the first and second transmission mechanisms T1 and T2 are both rolling ball type transmission mechanisms, but at least one transmission mechanism of the first and second transmission mechanisms of the present invention is not limited to the structure of the embodiment. That is, various types of transmission mechanisms including at least an eccentric rotating member and a second transmission member that enables spinning around a second axis and revolving around a first axis in association with rotation of the eccentric rotating member, for example, an internal planetary gear mechanism and a cycloidal reduction gear (speed-increasing gear) or a trochoidal reduction gear (speed-increasing gear) with various types of structures may can be applied to at least one of the first and second transmission mechanisms of the present invention.

Furthermore, in the embodiment each of the transmission grooves 21, 22; 24, 25 of the first and second transmission mechanisms T1 and T2 is a wave form annular wave groove along a trochoid curve, but these transmission grooves are not limited to those of the embodiment, and for example a wave form annular wave groove along a cycloid curve may be employed.

Moreover, in the embodiment the first and second rolling balls 23 and 26 are disposed as rolling bodies between the first and second transmission grooves 21 and 22 and between the third and fourth transmission grooves 24 and 25 of the first and second transmission mechanisms T1 and T2, but the rolling body may be a roller shape or a pin shape, and in this case the first and second transmission grooves 21 and 22 and the third and fourth transmission grooves 24 and 25 are formed so as to have an inside face shape on which a roller-shaped or pin-shaped rolling body can roll.

Furthermore, in the embodiment the eccentric rotating member 6 and the third transmission member 9 are connected (spline fitted) to the drive axles S1 and S2, which are supported on the differential case C, and are supported on the differential case C via the drive axles S1 and S2, but in the present invention the eccentric rotating member 6 and the third transmission member 9 may be supported directly on the differential case C.

Moreover, in the embodiment the first and second retaining members H1 and H2 are used in order to allow the first and second rolling balls 23 and 26 to roll smoothly, but in a case in which the first and second rolling balls 23 and 26 can smoothly roll without the first and second retaining members H1 and H2, the first and second retaining members H1 and H2 may be omitted.

1. A transmission device comprising
a first transmission member that is disposed so as to have a first axis as a central axis,
an eccentric rotating member that is formed by integrally linking to each other a main shaft portion that is rotatable around the first axis and an eccentric shaft portion that has as a central axis a second axis that is eccentric from the first axis,
a second transmission member that is rotatably supported on the eccentric shaft portion,
a third transmission member that is disposed so as to have the first axis as a central axis and opposes the second transmission member,
a first transmission mechanism that can transmit torque between the first and second transmission members while changing speed,
a second transmission mechanism that can transmit torque between the second and third transmission members while changing speed, and
a balance weight that is provided on the main shaft portion, has an opposite phase to an overall center of gravity of the eccentric shaft portion and the second transmission member with respect to the first axis, and has a rotational radius that is larger than a rotational radius of the overall center of gravity,
the second transmission member comprising a first half body that is rotatably supported on the eccentric shaft portion, a second half body that opposes the first half body while sandwiching a housing space for the balance weight, and a linking member that integrally links the two half bodies so as to surround the housing space, the first transmission mechanism being provided between the first half body and the first transmission member, and the second transmission mechanism being provided between the second half body and the third transmission member, and
the linking member having a first access window that enables an operation of inserting the balance weight into the housing space.

2. The transmission device according to claim 1, wherein the balance weight is relatively non-rotatably fitted on the main shaft portion, a retaining member that prevents the balance weight from disengaging from the main shaft portion is fitted on the main shaft portion, and the second half body has a second access window that enables an operation of fitting the retaining member on the main shaft portion.

3. The transmission device according to claim 1, wherein the second transmission member is formed from a sintered product in which the two half bodies and the linking member are integrally molded.

4. The transmission device according to claim 1,
the first transmission mechanism having a first transmission groove that is present in a face, opposing the first half body, of the first transmission member and has a wave form annular shape having the first axis as a center, a second transmission groove that is present in a face, opposing the first transmission member, of the first half body, has a wave form annular shape having the second axis as a center, and has a wave number that is different from that of the first transmission groove, and a plurality of first rolling bodies that are disposed on a plurality of intersecting parts of the first and second transmission grooves and carry out speed change and transmission between the first transmission member and the first half body while rolling on the first and second transmission grooves, and the second transmission mechanism having a third transmission groove that is present in a face, opposing the third transmission member, of the second half body and has a wave form annular shape having the second axis as a center, a fourth transmission groove that is present in a face, opposing the second half body, of the third transmission member, has a wave form annular shape having the first axis as a center, and has a wave number that is different from that of the third transmission groove, and a plurality of second rolling bodies that are disposed on a plurality of intersecting parts of the third and fourth transmission grooves and carry out speed change and transmission between the second half body and the third transmission member while rolling on the third and fourth transmission grooves.

5. A differential device utilizing the transmission device according to claim 4,
the differential device comprising a differential case that has power inputted and rotates integrally with the first transmission member around the first axis, the differential case having rotatably supported thereon a first drive shaft connected to the main shaft portion and a second drive shaft connected to the third transmission member, and (Z1/Z2)×(Z3/Z4)=2 being satisfied, where the wave number of the first transmission groove is Z1, the wave number of the second transmission groove is Z2, the wave number of the third transmission groove is Z3, and the wave number of the fourth transmission groove is Z4.

6. The transmission device according to claim 2, wherein the second transmission member is formed from a sintered product in which the two half bodies and the linking member are integrally molded.

7. The transmission device according to claim 2,
the first transmission mechanism having a first transmission groove that is present in a face, opposing the first half body, of the first transmission member and has a wave form annular shape having the first axis as a center, a second transmission groove that is present in a face, opposing the first transmission member, of the first half body, has a wave form annular shape having the second axis as a center, and has a wave number that is different from that of the first transmission groove, and a plurality of first rolling bodies that are disposed on a plurality of intersecting parts of the first and second transmission grooves and carry out speed change and transmission between the first transmission member and the first half body while rolling on the first and second transmission grooves, and the second transmission mechanism having a third transmission groove that is present in a face, opposing the third transmission member, of the second half body and has a wave form annular shape having the second axis as a center, a fourth transmission groove that is present in a face, opposing the second half body, of the third transmission member, has a wave form annular shape having the first axis as a center, and has a wave number that is different from that of the third transmission groove, and a plurality of second rolling bodies that are disposed on a plurality of intersecting parts of the third and fourth transmission grooves and carry out speed change and transmission between the second half body and the third transmission member while rolling on the third and fourth transmission grooves.

8. The transmission device according to claim 3,
the first transmission mechanism having a first transmission groove that is present in a face, opposing the first half body, of the first transmission member and has a wave form annular shape having the first axis as a center, a second transmission groove that is present in a face, opposing the first transmission member, of the first half body, has a wave form annular shape having the second axis as a center, and has a wave number that is different from that of the first transmission groove, and a plurality of first rolling bodies that are disposed on a plurality of intersecting parts of the first and second transmission grooves and carry out speed change and transmission between the first transmission member and the first half body while rolling on the first and second transmission grooves, and the second transmission mechanism having a third transmission groove that is present in a face, opposing the third transmission member, of the second half body and has a wave form annular shape having the second axis as a center, a fourth transmission groove that is present in a face, opposing the second half body, of the third transmission member, has a wave form annular shape having the first axis as a center, and has a wave number that is different from that of the third transmission groove, and a plurality of second rolling bodies that are disposed on a plurality of intersecting parts of the third and fourth transmission grooves and carry out speed change and transmission between the second half body and the third transmission member while rolling on the third and fourth transmission grooves.

9. The transmission device according to claim 6,
the first transmission mechanism having a first transmission groove that is present in a face, opposing the first half body, of the first transmission member and has a wave form annular shape having the first axis as a center, a second transmission groove that is present in a face, opposing the first transmission member, of the first half body, has a wave form annular shape having the second axis as a center, and has a wave number that is different from that of the first transmission groove, and a plurality of first rolling bodies that are disposed on a plurality of intersecting parts of the first and second transmission grooves and carry out speed change and transmission between the first transmission member and the first half body while rolling on the first and second transmission grooves, and the second transmission mechanism having a third transmission groove that is present in a face, opposing the third transmission member, of the second half body and has a wave form annular shape having the second axis as a center, a fourth transmission groove that is present in a face, opposing the second half body, of the third transmission member, has a wave form annular shape having the first axis as a center, and has a wave number that is different from that of the third transmission groove, and a plurality of second rolling bodies that are disposed on a plurality of intersecting parts of the third and fourth transmission grooves and carry out speed change and transmission between the second half body and the third transmission member while rolling on the third and fourth transmission grooves.

10. A differential device utilizing the transmission device according to claim 7,
the differential device comprising a differential case that has power inputted and rotates integrally with the first transmission member around the first axis, the differential case having rotatably supported thereon a first drive shaft connected to the main shaft portion and a second drive shaft connected to the third transmission member, and (Z1/Z2)×(Z3/Z4)=2 being satisfied, where the wave number of the first transmission groove is Z1, the wave number of the second transmission groove is Z2, the wave number of the third transmission groove is Z3, and the wave number of the fourth transmission groove is Z4.

11. A differential device utilizing the transmission device according to claim 8,
the differential device comprising a differential case that has power inputted and rotates integrally with the first transmission member around the first axis, the differential case having rotatably supported thereon a first drive shaft connected to the main shaft portion and a second drive shaft connected to the third transmission member, and (Z1/Z2)×(Z3/Z4)=2 being satisfied, where the wave number of the first transmission groove is Z1, the wave number of the second transmission groove is Z2, the wave number of the third transmission groove is Z3, and the wave number of the fourth transmission groove is Z4.

12. A differential device utilizing the transmission device according to claim 9,
the differential device comprising a differential case that has power inputted and rotates integrally with the first transmission member around the first axis, the differential case having rotatably supported thereon a first drive shaft connected to the main shaft portion and a second drive shaft connected to the third transmission member, and (Z1/Z2)×(Z3/Z4)=2 being satisfied, where the wave number of the first transmission groove is Z1, the wave number of the second transmission groove is Z2, the wave number of the third transmission groove is Z3, and the wave number of the fourth transmission groove is Z4.
